(19) United States
(12) Patent Application Publication
(10) Pub. No.: US 2009/0201200 A1
(43) Pub. Date: Aug. 13, 2009

(54) POSITIONING METHOD, POSITIONING ARRANGEMENT, BEARING DEVICE AND COMPUTER PROGRAM PRODUCT TO BE USED IN A POSITIONING SYSTEM

(75) Inventor: Hannu Lohi, Kello (FI)

Correspondence Address: YOUNG & THOMPSON, 209 Madison Street, Suite 500, ALEXANDRIA, VA, 22314, US

(73) Assignee: TRACKER OY, OULUNSALO (FI)

(21) Appl. No.: 12/304,922

(22) PCT Filed: Jun. 7, 2007
(86) PCT No.: PCT/FI2007/050334

§ 371 Date: Feb. 23, 2009

(30) Foreign Application Priority Data
Jun. 16, 2006 (FI) 20065412

(51) Int. Cl. G01S 1/00

(52) U.S. Cl. 342/357.07; 342/357.14

(57) ABSTRACT

A positioning method, positioning arrangement, bearing device (11) and computer program product for use in a positioning arrangement one described. The invention, the location information of the object being tracked can be visualized to the tracker (10), although exact coordinate information is not available. A bearing device (11) including an electronic compass is utilized in the arrangement according to the invention. The information concerning the signal level of the transmitter of the device (13) being tracked, measured and detected by the bearing device (11), and the corresponding compass heading are detected, and both are presented on an electronic map on the tracker's device (12). By the arrangement according to the invention, it is also possible to combine bearings taken of two or more locations on the same map.

The invention relates to a positioning method, positioning arrangement, bearing device and computer program product for taking a bearing to the object being positioned in circumstances in which it is not possible or necessary to create such a data transfer connection between the device of the tracker and the device of the object being positioned, by means of which the coordinates of the object to be positioned could be transferred to the electronic device used by the tracker.

Numerous radiotechnical solutions exist for positioning the object and taking a bearing to it. If the object to be positioned carries a radio transmitter, the radio transmitter can be positioned with a receiver comprising a directional antenna. The direction of the object is found by turning the directional antenna, and the distance can be estimated, for example, on the basis of the level of the received signal. On the basis of this, the person taking the bearing can estimate where the object being tracked is. A separate map can also be used as an aid in this. If the radio transmitter of the object being tracked is intended to be used only as a bearing transmitter, its structure can be kept simple. In that case, its power consumption can be kept low, and therefore a long operating time can be guaranteed for the batteries of the device. In addition, because the carrier wave used for taking a bearing need not contain any actual information to be transferred, a bearing can be taken even when the received signal is weak. The conventional dog radars utilize this principle.

If the radio transmitter carried by the object being positioned is of the kind that is used in cellular networks, it can be positioned to a certain area by means of two or more base stations of a cellular network. There are means installed in a cellular network, which can calculate the coordinates of the radio transmitter to be positioned either on the basis of the transit time or the reception power of the signal. The coordinate information can be transmitted to the person carrying out the positioning as a text message, for example. When required, the coordinate information can be presented on an electronic map base, for example.

Mobile positioning devices utilizing satellite positioning have also been developed for the determination of the location of objects. Satellite positioning is based on receiving signals transmitted by positioning satellites and calculating the location of the receivers on the basis of the distances of the satellites. The positioning devices on the commercial market use the satellite network of the Global Positioning System (GPS) of the USA. In the future, it will also be possible to utilize the European Galileo system.

The conventional satellite receiver is a separate device, which can present the positioning result either as coordinates or as a map display. There are also solutions in which the satellite signal receiver can be connected by a data transfer connection to a terminal device, which has a separate positioning application. The data transfer connection can be a Bluetooth connection, for example. The terminal device can be, for example, a mobile phone, a palm computer or a portable computer having a suitable positioning application loaded in its memory. A positioning device then means a unit consisting of a receiver, a terminal device and an application.

There are also solutions in which the positioning device has no satellite signal receiver. In that case, the user either indicates his position by means of a map shown on the display of the terminal device, or the user is positioned by means of the radio network utilized by him.

In the prior art positioning solutions, in which a map display is utilized, it is possible to set the device in different display modes, which have been designed to serve different situations of use. In the map display mode, there is a map base visible on the display of the positioning device, in which the user's own location, the location of the object that has been positioned and the location of the route points noted down are seen as graphical symbols. The part of the map shown on the display can be zoomed to the desired scale and rolled in different directions for showing the desired point in the terrain. In the prior art solutions, the user of the positioning device is generally shown in the middle of the map, and the map “moves” automatically to the right point according to the user's movements.

The map display usually also includes data fields showing information wanted by the user, such as the direction of movement of the person performing the positioning and the direction and distance to the object being tracked. In order to use the map display mode, there must naturally be a map of the area in question in the memory of the positioning device. In the arrow display mode, a compass circle and a direction arrow indicating the direction to the selected object are shown on the display of the positioning device. The data fields on the peripheral areas of the display show information wanted by the user, such as the speed of movement and the distance to the object.

Some positioning devices provided with a map display can also be set to track moving objects in addition to fixed ones. In that case, the object being tracked must have its own satellite positioning receiver or some other device giving location information, such as a device based on network positioning of a mobile phone, which has a data transfer connection to the positioning device used by the person tracking the object. In the prior art positioning devices, data transfer between the devices takes place via a GSM mobile communication network or other radio network.

Special applications for moving objects are systems intended for tracking hunting dogs. One prior art system utilizes GPS positioning. The system includes a dog-GPS device fastened to the harness of the hunting dog and a map-GPS device carried by the hunter. The dog-GPS device determines its location by satellite positioning and sends the information to the map-GPS device as a text message. After this, the hunter sees the dog's location in his own map-GPS device. The dog's location information can be updated at desired intervals. The hunter can set his map-GPS device in the arrow display mode, in which the direction arrow on the map shows in which direction the dog being tracked is.

In the positioning procedure described above, it must first be possible to position the object being tracked by a suitable method, if the place of the object being tracked is wanted to be shown on a suitable map display. In addition, it must be possible to transmit the positioning information via a suitable data transfer network to the map-GPS device of the person performing the tracking.

If the satellite positioning signal cannot be received, for example, which may be the case inside buildings or below ground, for example, positioning will not succeed. On the other hand, if positioning can be performed, the positioning results must be transferred to the device of the person performing the tracking. Data transfer can take place by utilizing some existing data transfer network. For example, among the data transfer networks that can be used are the prior art cellular networks and wireless local area networks. One method which can be utilized in the selection of a data transfer network for location information has been presented in the Finnish patent application F120055102 by the same applicant. If either the tracked person or the tracker is beyond the reach of all suitable data transfer networks, the transfer of positioning information from the object to be positioned to the device of the person performing the positioning will not succeed. Then the only remaining alternative will be taking a bearing to the object being tracked by means of a radio transmission.

The objective of the invention is to provide a new method and device arrangement, by which the positioning of the object being tracked can be performed and shown on the map base of the device used by the tracker, although there is no information about the location of the object being tracked or it cannot be transferred from the device of the object being tracked to the tracker's device via a radio network.

The objectives of the invention are achieved by a method, positioning arrangement and an application, which are characterized in what is set forth in the characterizing parts of the independent claims.

Some preferred embodiments of the invention are presented in the dependent claims.

The invention has the advantage that the positioning of the object being tracked can be performed and shown visually on a map, although there is no possibility to transfer exact positioning information between the tracker's positioning device and the device of the object being tracked.

In addition, the invention has the advantage that the direction and distance of the object being positioned can be shown on the map display of the device used by the tracker.

Another advantage of the invention is the fact that the measurement information of two or more positioning devices can be combined for making the positioning of the object being tracked more accurate.

Yet another advantage of the invention is the fact that for finding the direction of the object being tracked, only information about the method of transmission and frequency used by the radio transmitter of the object being tracked is needed, and therefore any radio transmission can be utilized in the positioning.

Some advantageous embodiments of the invention are presented in the dependent claims.

The basic idea of the invention is the following: The tracker of the object advantageously has a map base saved in an electronic device, and a radio bearing device. In addition, the electronic device may also include a satellite positioning device, such as a GPS positioning device. The map base used by the tracker is shown on the display of the electronic device used by the tracker. The location of the tracker obtained as a result of satellite positioning, for example, is shown on the map by a graphical symbol. The positioning result shown may also be a result of some other positioning procedure utilized.

If the device carried by the object being positioned does not have positioning means, or a radio connection cannot be established to it via a data transfer network, although it has positioning means in which the information of a positioning carried out has advantageously been saved, the direction and distance estimate of the object being tracked can be performed by a direction finding device according to the invention used by the tracker. The direction finding device advantageously comprises a directional antenna and an electronic compass. By turning the direction finding device and monitoring the strength of the signal received, it can be found out in which direction the radio transmitter carried by the object being tracked is. The level of the signal received by the bearing device and each reception direction indicated by the electronic compass are transmitted to the tracker's electronic device. The electronic device combines this information with the map base in the device. Then the direction from the point representing the tracker on the map to the object being tracked can advantageously be shown on the map base of the tracker's electronic device. A distance estimate can also be made on the basis of the level of the signal received, and it can be presented on the map base if the power of the transmitter of the object being tracked and the shapes and possible obstacles of the terrain are known.

In the following, the invention will be described in detail. Reference will be made to the accompanying figures, in which

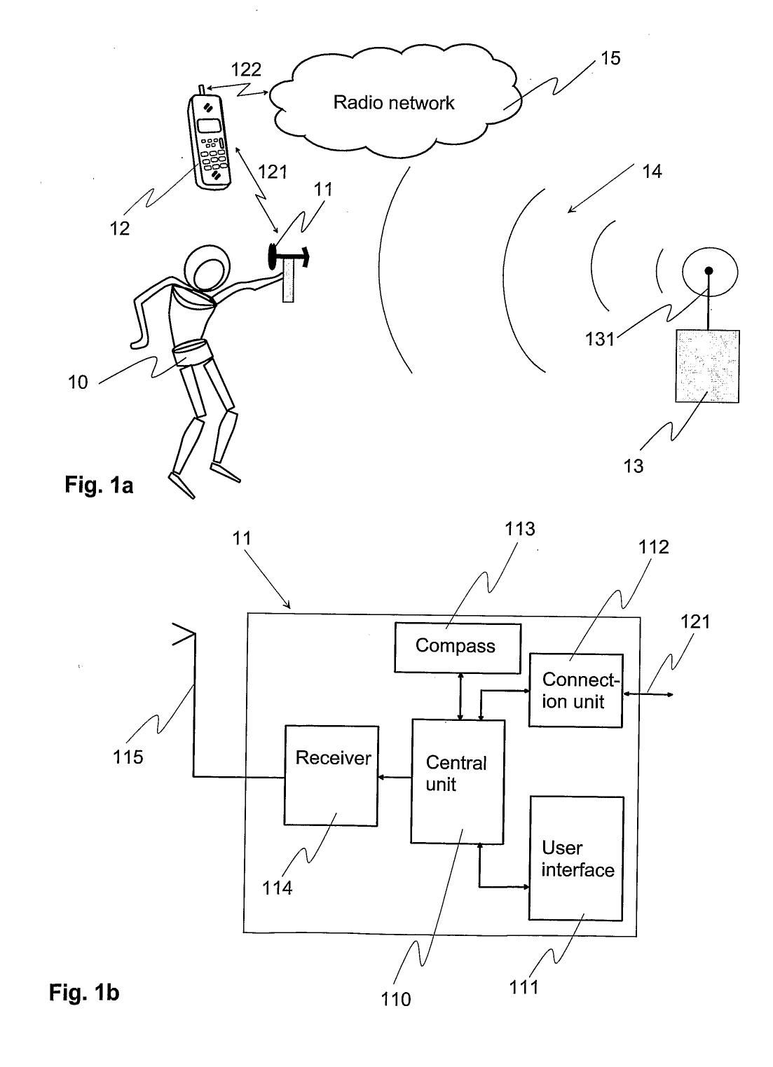

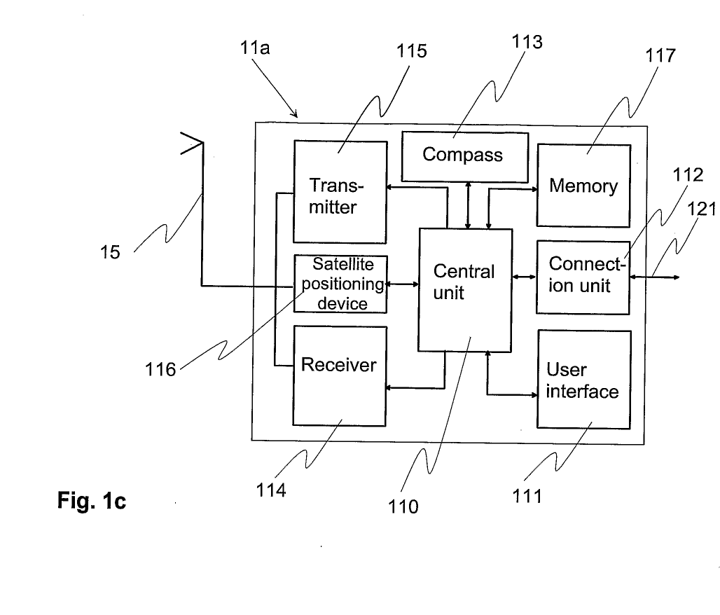

FIG. 1a shows the positioning arrangement according to the invention by way of example,

FIG. 1b shows the bearing device according to the first embodiment of the invention by way of example,

FIG. 1c shows the bearing device according to the second embodiment of the invention by way of example,

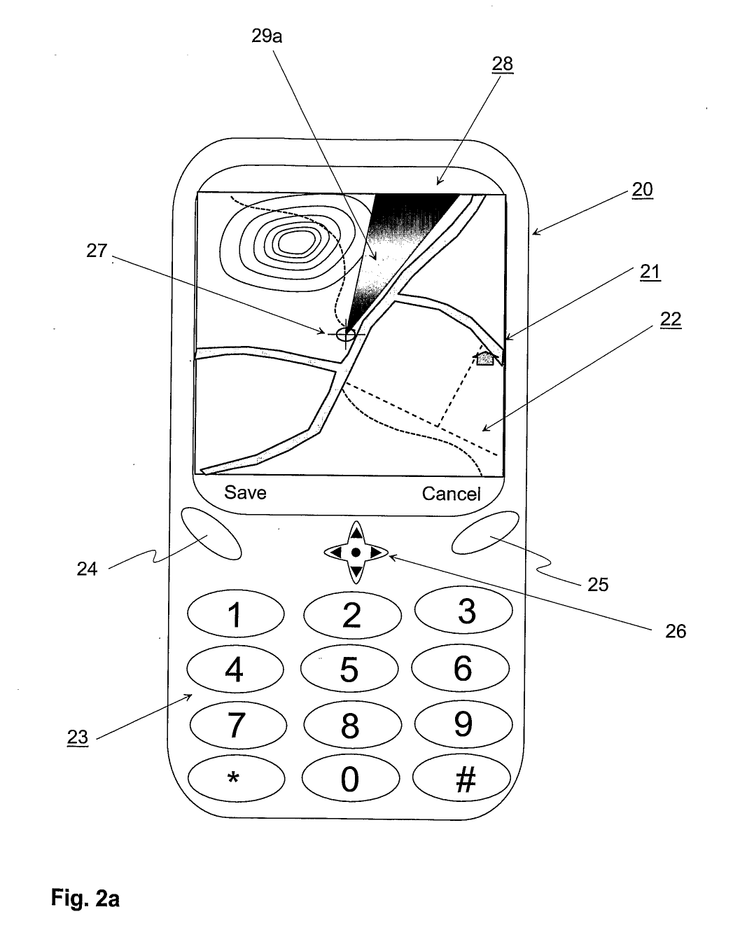

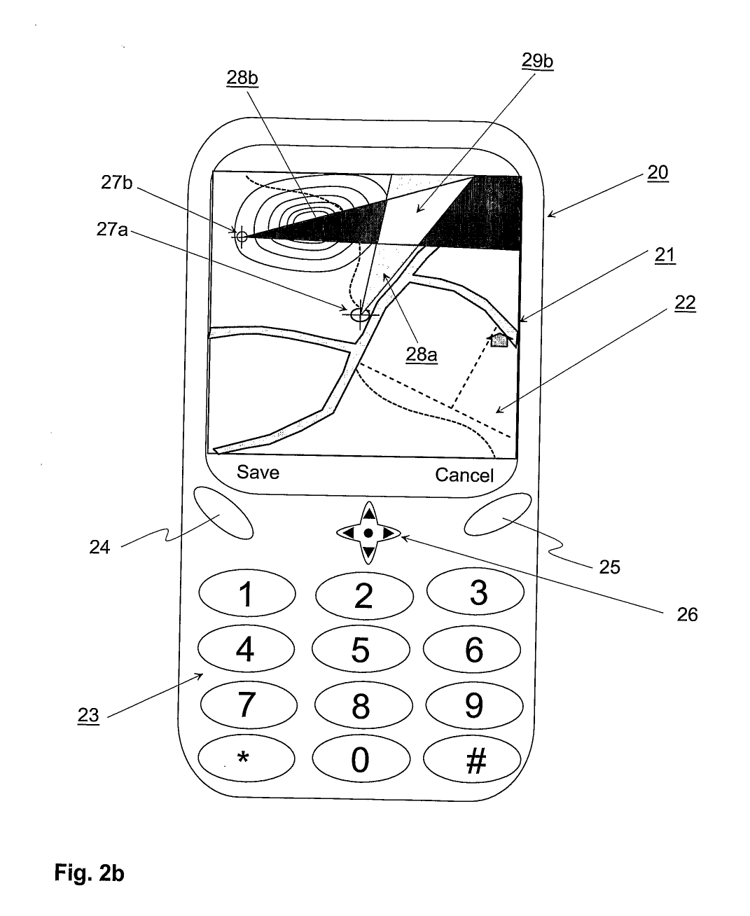

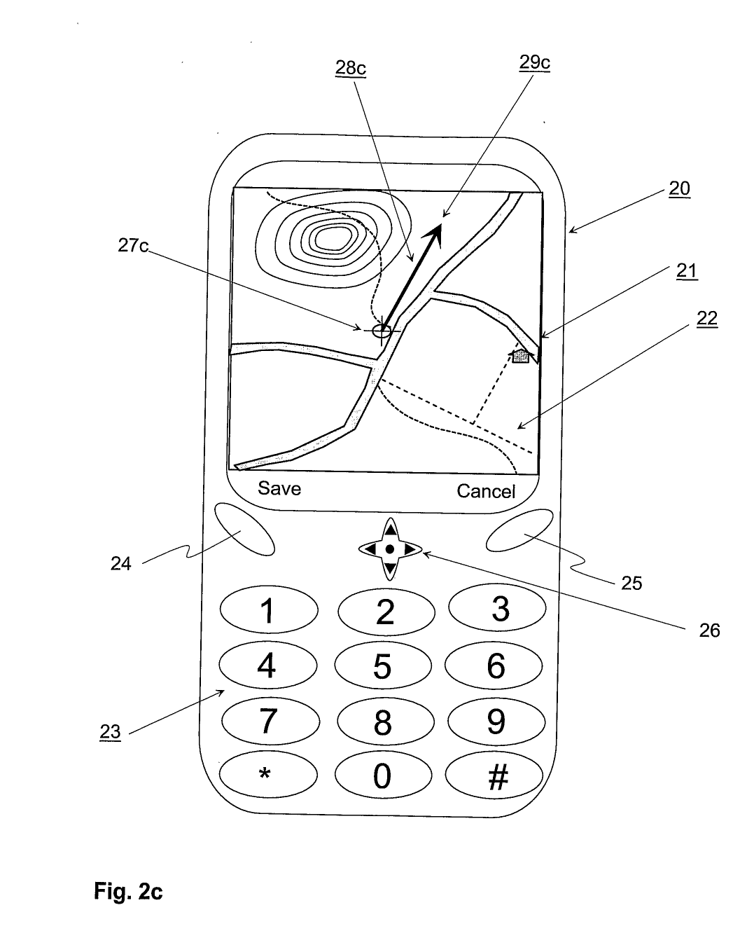

FIG. 2a shows an example of a sector-shaped positioning result when one bearing result is used,

FIG. 2b shows an example of a sector-shaped positioning result when two bearing results are used,

FIG. 2c shows an example of a positioning result presented by an arrow when one bearing result is used, and

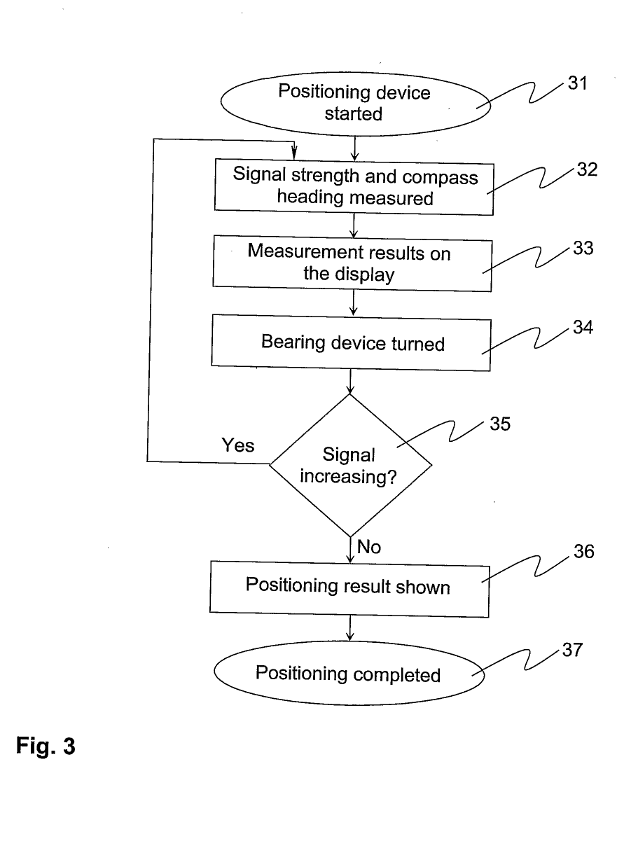

FIG. 3 shows, by way of example, a flow chart of the main steps of the positioning method according to the invention.

In the following, the invention will be described by means of exemplary embodiments. In connection with the figures and the related description, the example used is mainly a case in which the object being tracked carries a satellite positioning device. However, the invention can also be applied in cases in which no separate positioning devices carried by the object being tracked are available. Even in this case, the positioning can be performed and shown to the tracker on an electronic display device by the procedure according to the invention. Utilizing the procedure according to the invention only requires that the device of the object being tracked sends some radio transmission, which can be received by the radio direction finding device used by the tracker. The direction-finding result obtained by the bearing device is presented on a map base on the display of the electronic device used by the tracker.

FIG. 1a shows an example of a positioning arrangement according to the invention, in which satellite positioning and a cellular network is utilized. Ref. no. 13 indicates a device carried by the object being tracked. The object being tracked can be a human, animal, object or a car. In the example of FIG. 1a, the device 13 of the object being tracked advantageously also comprises a satellite positioning device, such as a GPS positioning device or means for performing the positioning by means of a terrestrial radio network. The geographical coordinates of the object are found out by positioning. Hereinafter, this procedure is generally called positioning, and the device is called a positioning device.

In addition, the device 13 of the object being tracked according to the example of FIG. 1a comprises at least the prior art transmission means required in at least one radio network (not shown in detail in FIG. 1a). Device 13 also comprises an antenna 131, which is advantageously of the omnidirectional type. By means of the positioning device, which is advantageously included in the device 13, the exact location of the object being positioned can be determined at the desired time.

A person 10 tracks the object, utilizing another electronic device 12. The electronic device 12 can be advantageously a terminal device of a cellular network, a PDA (Personal Digital Assistant), palm computer or a portable computer. The electronic device 12 comprises means by which it can connect to a wireless data transfer network 15, such as a GSM, GPRS, UMTS or WLAN network. Data transfer between the electronic device 12 and the radio network 15 is indicated by reference number 122. In addition, the electronic device also 12 comprises a suitable display device for presenting graphical information, a processor and a memory for saving the application programs and the information shown by the device.

In the example of FIG. 1a, the tracker 10 gets the information of the positioning performed by the device 13 carried by the object being tracked by means of a connection 122 established in a suitable wireless radio network 15. The tracker's electronic device 12 receives the coordinates determined by the device 13 and transmitted to the radio network 15. The electronic device 12 combines the location information of the object being tracked to a map shown on the display of the electronic device 12.

However, there are situations in which either the tracker 10 or the object being tracked is beyond the reach of all available radio networks 15, or the positioning device is not able to determine the coordinates of the object. Then the radio connection 122 cannot be utilized for transferring the coordinate information of the object being tracked to the tracker's device 12. In this case, the tracker 10 can utilize the bearing device 11 in accordance with the invention. In an advantageous embodiment, the bearing device 11 comprises a directional antenna, a receiver with a detector, an electronic compass, a processor and means for transferring the bearing and compass information to the electronic device 12 used by the tracker. Data transfer can take place either via a cable or wirelessly, ref. no. 121. In wireless applications, an infrared connection, a Bluetooth connection or a ZigBee connection can advantageously be used. Data transfer can also be implemented via a prior art cellular network or a wireless local area network.

In another advantageous embodiment of the invention, the bearing device 11 also comprises a suitable display device, a transmitter, a memory, user interface means and means for utilizing a radio network. In this embodiment, a separate electronic device 12 is not necessarily needed in the positioning procedure according to the invention.

A separate bearing device 11 and an electronic device 12 are used in the following example. When the tracker 10 sees that a data transfer connection 122 cannot be established or it has not been possible to perform positioning in such a way that the coordinates of the object being tracked could be sent, he starts using the bearing device 11. In an advantageous embodiment of the invention, the tracker 10 sends a radio signal, which starts a separate bearing transmitter in the device 13 of the object being tracked. Then the device 13 transmits radio waves 14, the incoming direction of which the tracker 10 looks for with the positioning device 11. Depending on the beam width of the directional antenna, by monitoring the level of the received signal, the tracker 10 will find out in which sector the device 13 being tracked is. A rough distance to the device 13 can be estimated if the transmission power of the transmitter, land cover and obstacles in the terrain are known. The distance estimate of the object can be presented either as a numerical value, a graphical character string or by means of the colours or filling of the figure indicating the direction.

In the positioning arrangement according to the invention, the bearing device 11 also comprises an electronic compass. The level of the received signal and the current compass direction are advantageously either saved in the memory of the bearing device 11 or transferred directly to the memory of the electronic device 12 used by the tracker 10. By combining the measured reception level of the signal and the compass direction to a map shown on an electronic device 12, the direction of the object being tracked can be shown on the map of the electronic device 12, although the data transfer of the location coordinates is not available. The accuracy of the direction shown depends on the beam width of the antenna of the bearing device 11.

In another embodiment according to the invention, the bearing device 11 does not transmit a signal by which the bearing transmitter of the device 13 is started, or the object does not have a separate bearing transmitter at all. In this embodiment, the tracker 10 knows that the device 13 being tracked tries to establish or is capable of establishing a data transfer connection to a radio network 15 known by the tracker, or it may function as a mere bearing transmitter transmitting a carrier wave. The bearing device 11 can receive this carrier wave of radio communications and utilize it in taking a bearing to the object to be positioned in the manner described in connection with the first embodiment.

The result of the positioning can be improved further by taking a bearing consecutively of two or more locations with the same bearing device 11. Because the bearing results can be saved in the memory of the electronic device 12, they can also be combined in the desired manner. Combining two or more bearing results from the memory of the electronic device 12 makes the location of the object being tracked more accurate on the map.

If the tracker 10 uses an electronic device 12, which is connected to a wireless data transfer network 15, the tracking result can also be improved in the following manner. The bearing is taken by two or more bearing devices 11 according to the invention approximately simultaneously. The bearing results are transferred via a wireless data transfer network 15 either to one or more tracker's 10 device(s) 12. By combining the bearing results of different devices, the positioning of the object can be made more accurate on the map display.

FIG. 1b shows the functional blocks of a bearing device 11 according to an advantageous embodiment of the invention as an exemplary flow chart. In this embodiment, the tracker 10 must have another electronic device 12, which is utilized for presenting the result of the positioning. In this embodiment, the electronic device 12 may also include a satellite positioning device. The tracker's position can also be determined and the location information be saved in the electronic device 12 by means of a cellular network or by inputting the coordinates manually by means of the user interface of the electronic device 12.

The bearing device 11 according to the invention comprises a receiver 114 and a directional antenna 115, by using which the reception direction of the radio transmitter to be positioned can be determined. The beam width used in direction finding is mainly determined by the structure of the directional antenna 115. When in the bearing mode, the receiver 114 can be used to receive the carrier wave of a separate bearing radio transmitter or various radio networks within the limits defined by the structure of the directional antenna.

The operation of the bearing device 11 is controlled by a central unit 110. At its simplest, the user interface 111 comprises the control buttons of the bearing device 11 and means for indicating the level of the received signal. The indicating means can be based either on a sound, which is proportional to the signal level obtained from the receiver 114, or graphical indication of the level of the received signal.

The bearing device 11 according to the invention also comprises an electronic compass 113. The compass 113 advantageously indicates the direction in which the reception beam of the directional antenna 115 points at each time. The reading of the compass 113 together with the level of the received signal can advantageously be transferred to another electronic device 12 via a connection unit 112. The connection to another electronic device 12 can be realized either as a wired or wireless data transfer connection 121.

FIG. 1c shows another advantageous embodiment 11 a of the bearing device. The bearing device of FIG. 1c comprises all the functional parts of the bearing device according to FIG. 1b. In addition, it comprises a suitable memory 117, which can also be a part of the central unit 110 of the bearing device. In this embodiment, the user interface 111 also comprises a display unit, by which the results of the bearing taken can be shown as placed on the map.

In addition, in this embodiment the bearing device 11 preferably advantageously a satellite positioning device 116, such as a GPS positioning device. The positioning information can advantageously be saved in the memory 117 of the bearing device 11. Because the bearing device 11 additionally comprises a suitable display device, in this embodiment the bearing device 11 can operate as an entirely independent positioning device without the need to transfer positioning results to some other electronic device 12.

Furthermore, the bearing device 11 according to this embodiment may comprise a transmitter 115, by means of which the bearing device 11 can transmit instructions to the device 13 of the object being tracked. The transmitter 115 and the receiver 114 can also be arranged to operate in a suitable radio network 15. Examples of possible radio networks are cellular networks, wireless local area networks, Bluetooth networks or ZigBee networks. When required, the bearing device 11 can then also transmit its bearing information to another electronic device connected to the same data transfer network 15, such as a terminal device 12 of a cellular network.

FIGS. 2a to 2c show examples of embodiments of the invention, in which a separate electronic device 20 is utilized for presenting bearing information. In the examples, a commercially available map application has been installed in the electronic device 20.

FIG. 2a shows an exemplary terminal device 20 of a cellular network, which is used by the tracker 10 and to which the information of the separate bearing device 11 according to the invention is transferred. It is obvious to a person skilled in the art that the invention can also be utilized in other mobile, electronic devices than the terminal device of a cellular network according to FIG. 2a. The terminal device 20 of FIG. 2a comprises a prior art keyboard 23, one or more prior art programming keys 24 and 25, a direction key 26 and a display 21. In the example of FIG. 2a, either the map base or the graphical symbol representing the tracker 10 can be rolled in the desired direction on the display of the terminal device 20. The positioning result can be saved or removed from the display of the terminal device 20 by the programmable keys 24 and 25. In addition, the terminal device 20 comprises a processor controlling its operation, a suitable memory and transmitter and receiver means, by using which the terminal device 20 can connect to a suitable radio network (not shown in FIG. 2a).

In the example of FIG. 2a, a positioning result according to the first embodiment of the positioning method according to the invention is shown on the display 21 of the terminal device 20. A map view 22 is shown on the display 21. The tracker 10 has positioned himself advantageously by a satellite positioning device belonging to the terminal device 20 or capable of transferring positioning information to it, or by means of a terrestrial radio network. In an advantageous embodiment of the invention, the tracker saves the coordinates of his own location manually, utilizing the user interface of the electronic device used by him. When the obtained positioning result has been saved in the terminal device 20, it can be represented by a symbol shaped like a sight 27 on the map 22 in the example of FIG. 2a. The map display of the terminal device 20 is advantageously set in such a way that the tracker's 10 location is approximately at the centre of the map 22 displayed.

The tracker 10 positions the radio transmitter of the object being tracked by turning the bearing device 11 in different directions. The signal detected by the bearing device varies according to the reception direction. In an advantageous embodiment of the invention, the compass reading of the direction which provides the highest level of reception is saved in the memory of the terminal device 20. This compass heading is used as the central axis of the positioning sector drawn on the map 22. When the beam width of the directional antenna used by the bearing device 11 is known, a sector 28 can be drawn on the map base 22 from a point 27 representing the tracker 10 to the positioned compass direction. The object to be positioned is located in the sector 28 drawn on the map 22.

In an advantageous embodiment of the invention, the estimated location 29a of the object is indicated by the colour of the sector 28, the pattern used to fill it with or a graphical image.

FIG. 2b shows an advantageous embodiment of the invention. Two results of bearings taken at different places are utilized in it. The first result, sector 28a, has been obtained by taking a bearing from point 27a. The second result, sector 28b, has been obtained by taking another bearing from point 27b. By combining the bearing results, it is possible to determine their intersection area 29b, in which the object to be positioned is.

The bearing results 28a and 28b can be obtained from one and the same bearing device 11 or two or more separate bearing devices. If the same bearing device 11 has been used, the person 10 taking the bearing has moved from place 27a to place 27b between the bearing measurements taken. After the second bearing has been taken, the results of both bearings are combined on the map display 22, whereby the view according to FIG. 2b is obtained.

In another advantageous embodiment of the invention, bearings are taken of the object simultaneously with at least two separate bearing devices. In this embodiment, the bearing devices must be capable of transferring the bearing results to at least one terminal device 20 of a party which participated in the bearing. This can be carried out advantageously by using the GSM or GPRS network 15, for example.

FIG. 2c shows an advantageous embodiment of the invention. In this embodiment, the sector presentation of taking a bearing has been replaced by a direction arrow 28c. Such an embodiment is advantageous if the beam width of the directional antenna of the bearing device 11 is narrow to begin with, or it can be made narrower for making the bearing more accurate. In that case, the length of the direction arrow 28b can advantageously also be used to indicate the assumed location 29c of the object being positioned, if the transmission power of the radio transmitter 13 of the object to be positioned and the shape and land cover of the terrain are known.

The arrangement according to this embodiment can advantageously be utilized during the actual bearing measurement. When the antenna of the bearing device 11 is turned, the length of the direction arrow 28c also changes according to the signal strength that can be measured from the reception beam of the antenna of the bearing device 11. The direction from which the highest signal level is received indicates the direction of the object being positioned.

In an advantageous embodiment of the invention, the length of the direction arrow 28c after the measurement in different directions of reception can also be presented graphically on the display 21 of the terminal device 20.

FIG. 3 is an exemplary flow chart of the main steps of the positioning method according to the invention. In step 31, the bearing device 11 according to the invention is started. In step 32, the bearing device 11 is turned in the direction where the object to be positioned is assumed to be. The level of the received signal and the corresponding compass heading are saved in the memory of either the electronic device or the bearing device used. In step 33, the level of the received signal and the compass heading are shown on a suitable electronic display. Loaded on the display there may be a suitable map base, on which the level of the received signal and the direction information is presented. After this, in step 34, the bearing device 11 is deviated from its original direction. In step 35 it is checked whether the deviation caused an increase in the received signal level or not. If the signal level increased, the method returns to step 32, in which a new signal level and compass heading are saved.

When the bearing device 11 is further deviated in this manner, after some deviation the received signal does not increase any more, because the centre of the beam of the directional antenna of the bearing device 11 no more points towards the transmitter 13 carried by the object being positioned. Then, in step 35, the direction of the object being positioned can be determined. The best bearing result, the highest received signal level, is saved and presented on an electronic device used by the tracker 10.

The best bearing result is advantageously combined with the positioning result of the tracker concerning his own location, whereafter the bearing result can be shown as a figure on a suitable map base, step 36. Active positioning ends at step 37.

The positioning and visualizing method according to FIG. 3 can be implemented by a program application installed in the electronic device 20. The program application needed for applying the invention can be saved in the memory of the electronic device 20. The processor unit of the electronic device performs the procedures defined in the program application, by which the steps of the process according to FIG. 3 are implemented. By means of the program application according to the invention, a map base 22 can be presented on the display 21 of the electronic device 20, on which map base both the symbol representing the tracker 27 and the bearing result of the object being positioned can be presented simultaneously.

Some advantageous embodiments of the method and device according to the invention have been described above. However, the invention is not limited to the embodiments described above. In an advantageous embodiment, a map base is not utilized at all. In this embodiment, a device arrangement according to the invention can be used to present the direction and distance of the object being positioned like a compass. In addition, the inventive idea can be applied in numerous ways within the scope defined by the attached claims.

1-24. (canceled)

25. A method for positioning an object, in which method:
a tracker (10) of an object positions (36) his location;
the tracker's positioning result (27, 27a, 27b, 27c) is presented (36) on a map (22) on the display (21) of a mobile electronic device (12, 20) of the tracker;
a radio transmission (14) is transmitted by a radio transmitter (13) carried by an object being positioned;
a bearing is taken of the radio transmission (32-34) of the object being positioned by at least one bearing device (11); and
a compass heading (28, 28a, 28b, 28c) of the object being positioned is determined (35) at the location at which the bearing is taken (27, 27a, 27b, 27c), characterized in that:
the compass heading of the object being positioned is shown on the map (22) on the display (21) of the mobile electronic device (12, 20) of the tracker (10) starting from each location at which a bearing was taken (27, 27a, 27b, 27c).

26. The method according to claim 25, characterized in that the determined compass heading (28, 28a, 28b, 28c) is transferred from the bearing device (11) to the mobile electronic device (12) for presenting the bearing result on the map (22) on its display (21).

27. The method according to claim 25, characterized in that the determined compass heading (28, 28a, 28b, 28c) is shown on a map (22) on a display device belonging to the bearing device (11).

28. The method according to claim 26, characterized in that the compass headings (28a, 28b) of two or more bearings taken are combined on the map (22) on the display (21) of the mobile electronic device (12), whereby, as a result of the combining, an intersection area 29b is formed on the map, in which intersection area the object being positioned is located.

29. The method according to claim 28, characterized in that all the bearings to be combined are taken by two bearing devices, and that all the bearing results are transferred via a radio network (15) to at least one mobile electronic device (12) for combining the bearings.

30. The method according to claim 25, characterized in that a probable distance of the object being positioned from the location of positioning (27, 27a, 27b) is determined by means of the strength of the received signal.

31. The method according to claim 25, characterized in that the tracker (10) of the object positions his location by a satellite positioning device, using a terrestrial radio network or by means of a map, and that the positioning information is saved in the electronic device (12, 20).

32. A positioning arrangement, which comprises:
means for determining a location (27, 27a, 27b) of a tracker (10) of an object;
means for presenting the location of the tracker (27, 27a, 27b) and the object being positioned on an electronic map (22) on the display (21) of a mobile electronic device (12, 20) of the tracker;
a radio transmitter (13) of the object being tracked; and
at least one bearing device (11) for taking a bearing to the radio transmitter (13) of the object being tracked;
an electronic compass (113) belonging to the bearing device (11) for determining a compass heading of the object being tracked at the location (27, 27a, 27b) at which the bearing is taken,
characterized in that it further comprises:
means for presenting the compass heading of the object being positioned on the basis of the bearing result, starting from each location at which a bearing was taken (27, 27a, 27b, 27c), on the map (22) on the display (21) of at least one mobile electronic device (12, 20) of the tracker (10).

33. The positioning arrangement according to claim 32, characterized in that the bearing device (11) comprises means for transferring the determined compass heading (28, 28a, 28b, 28c) from the bearing device (11) to the mobile electronic device (12) of the tracker (10) for presenting the bearing result on the map (22) on its display (21).

34. The positioning arrangement according to claim 32, characterized in that the bearing device (11) comprises means for presenting the determined compass heading (28, 28a, 28b, 28c) on a map on a display device belonging to the bearing device (11).

35. The positioning arrangement according to claim 32, characterized in that it comprises means for combining the compass headings (28a, 28b) of two or more bearings taken on the map (22) on the display (21) of the mobile electronic device (12), whereby, as a result of the combining, an intersection area 29b can be formed on the map, in which intersection area the object being positioned is located.

36. The positioning arrangement according to claim 32, characterized in that the means for determining the location (27, 27a, 27b) of the tracker (10) of the object comprise one of the following: a satellite positioning device, a terrestrial radio network or a map.

37. The positioning arrangement according to claim 32, characterized in that it comprises a radio network (15), via which the bearing results can be transferred to at least one mobile electronic device (12) for combining the bearings (28a, 28b).

38. The positioning arrangement according to claim 37, characterized in that the radio network (15) is one of the following: a GSM, GPRS, UMTS or WLAN radio network.

39. A bearing device (11), which comprises:
a directional antenna (116), a receiver (114) and a central unit (110) for determining the direction of a radio transmission (14) from an object to be positioned,
characterized in that the bearing device also comprises:
an electronic compass (113) for determining a compass heading of an object being positioned, which compass heading can be combined to an electronic map (22).

40. The bearing device according to claim 39, characterized in that it also comprises a connection unit (112) for transferring the signal level received by the receiver (114) from a certain direction and the heading of a corresponding electronic compass (113) to another mobile electronic device (12, 20).

41. The bearing device according to claim 40, characterized in that it also comprises:
a satellite positioning device (116)
a memory (117)
a display device, and
means for showing the bearing result on an electronic map (22) on the display device of the bearing device (11).

42. The bearing device according to claim 40, characterized in that it also comprises a transmitter (114), by which it is arranged either to transmit instructions to a device (13) of the object being tracked or to connect wirelessly to another mobile electronic device (12, 20).

43. A computer program product, which comprises computer program means saved on a computer-readable medium for presenting a positioning result of an object being positioned on a map (22) on the display (21) of a mobile electronic device (12, 20), on which the location (27, 27a, 27b) of the mobile electronic device determined by separate location determination is shown, characterized in that the computer program product also comprises computer program means for presenting a direction of the object to be positioned determined by a bearing device (11) on the map in relation to the location (27, 27a, 27b, 27c) of said mobile electronic device.

44. The computer program product according to claim 43, characterized in that it also comprises computer program means for indicating the direction of the object being positioned as a sector (28, 28a, 28b) starting from the location (27, 27a, 27b) on the map of the mobile electronic device.

45. The computer program product according to claim 43, characterized in that it also comprises computer program means for indicating the direction of the object being positioned as an arrow (28c) starting from the location (27c) on the map of the mobile electronic device.

46. The computer program product according to claim 43, characterized in that it also comprises computer program means for combining the results of two or more bearings for forming an intersection area (29b) on the map (22), in which intersection area the object being positioned is located.

47. The computer program product according to claim 43, characterized in that it also comprises computer program means for estimating and presenting a distance to the object being positioned on the basis of the level of the signal received from the object being positioned.

48. The computer program product according to claim 43, characterized in that it also comprises computer program means for presenting the location (29a) of the object being positioned by means of the colouring of the sector (28) drawn on the map (22), its filling pattern or a separate graphical image.
